(19) United States
(12) Patent Application Publication
(10) Pub. No.: US 2003/0200992 A1
(43) Pub. Date: Oct. 30, 2003

(54) Washing station for landscape maintenance equipment

(75) Inventor: Sidney Goldman, Boca Raton, FL (US)

Correspondence Address: Martin Sachs, 6375 Pointe Pleasant Circle, Delray Beach, FL, 33484, US

(73) Assignee: Mechanical Manufacturing Corporation

(21) Appl. No.: 10/135,011

(22) Filed: Apr. 30, 2002

(51) Int. Cl. B08B 13/00; B60S 3/04

(52) U.S. Cl. 134/10; 134/111; 134/123

(57) ABSTRACT

A washing station and method for removing debris and oil from landscape maintenance equipment vehicles includes a self-contained pressurized washing system that separates the washing water from solids, washes the solids, captures the oil and debris, recycles the filtered water and prevents contamination of the surrounding area.

### BACKGROUND OF THE INVENTION

1. Field of the Invention

The present invention relates to a pressurized washing system and apparatus, and more particularly, to a self-contained washing system that is capable of simultaneously washing a plurality of vehicles used for landscape maintenance, removing the debris and oils from the vehicles, while separating and removing the oil from the debris and the wash water, utilizing recycled and filtered water, without contaminating the surrounding area.

2. Discussion of the Relevant Art

The prior art discloses many devices for providing a pressurized washing system suitable for washing the underside and top of lawnmowers and the like. However, a pressurized washing system that is capable of simultaneously washing the debris from of a plurality of vehicles, filtering the liquids, separating the water from the oils and having a storage medium for holding the removed oil and debris for disposal elsewhere, thereby avoiding contamination of the environment proximate the washing station, does not appear in the related art and there is no showing or suggestion that such an environmentally protective apparatus is capable of performing the same functions.

### SUMMARY OF THE INVENTION

Therefore, it is an object of the present invention to overcome the shortcomings of the prior art and provide a pressurized washing system, suitable for simultaneously washing a plurality of vehicles, that is safe for the environment.

It is an object of the present to provide a self-contained, pressurized washing station that filters the liquid used in the washing of a plurality of vehicles for re-use and captures the debris contained in the liquid for disposal without contaminating the environment.

It is another object of the present invention to provide a relatively inexpensive self-contained pressurized washing apparatus for a plurality of vehicles that may readily be moved and installed in another location.

It is yet another object of the present invention to provide a self-contained, pressurized washing station that filters and re-uses the washing water that washes a plurality of vehicles and stores the debris contained in the water for disposal without contaminating the environment.

It is still yet another object of the present invention to provide a pressurized washing station that may simultaneously accommodate a plurality of vehicles of different sizes, re-uses the washing water, cleans and stores the debris contained in the water for disposal, without contaminating the environment.

Yet another object of the present invention is to provide a pressurized washing station that is self-contained, does not require an external source of water or electricity or requires a sewer system and is powered by a diesel power pneumatic source that provides the required water pressure for operation.

Still yet another object of the present invention is to provide a system that captures and uses available rain water to replace and supplement needed water.

The foregoing and other objects and advantages will appear from the description to follow. In the description, reference is made to the accompanying drawing, which forms a part hereof, and in which is shown by way of illustration a specific embodiment in which the invention may be practiced. This embodiment will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims. Like-reference characters are utilized to designate like or corresponding components in the various views, in order for the reader to better understand features of the invention.

### BRIEF DESCRIPTION OF THE DRAWINGS

In order that the invention may be more fully understood, it will now be described by way of example, with reference to the accompanying drawings in which:

FIG. 1 is a top plan view of a washing station for a plurality of landscape maintenance equipments, according to the principals of the present invention;

FIG. 2 is an enlarged plan view of the power and control portion of the washing station described in FIG. 1; and

FIG. 3 is a flow diagram of the washing station showing the flow, recycling of the water and the storage and the disposal of the waste materials accumulated after washing the vehicles.

### DESCRIPTION OF THE PREFERRED EMBODIMENT

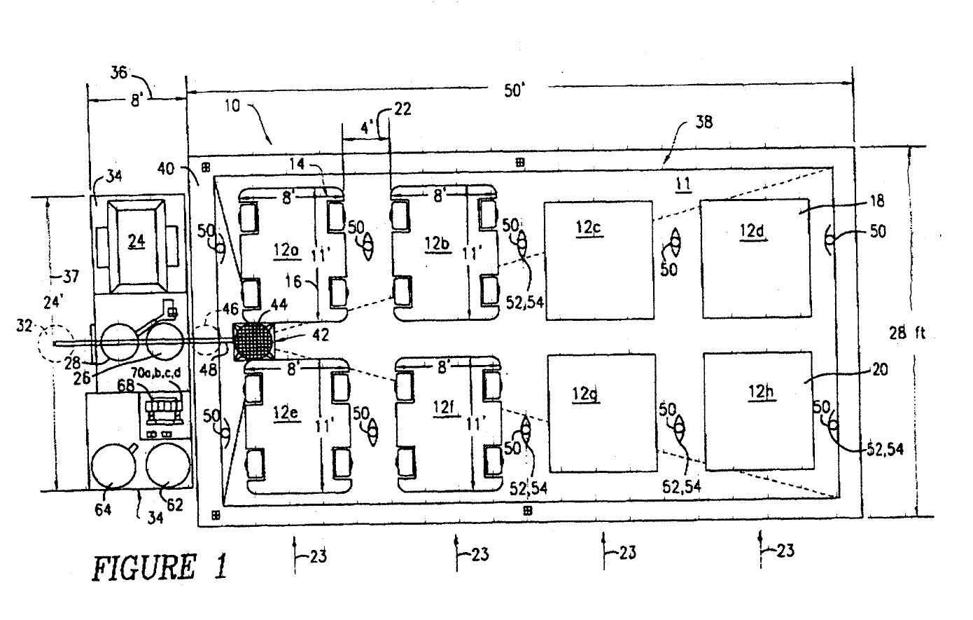

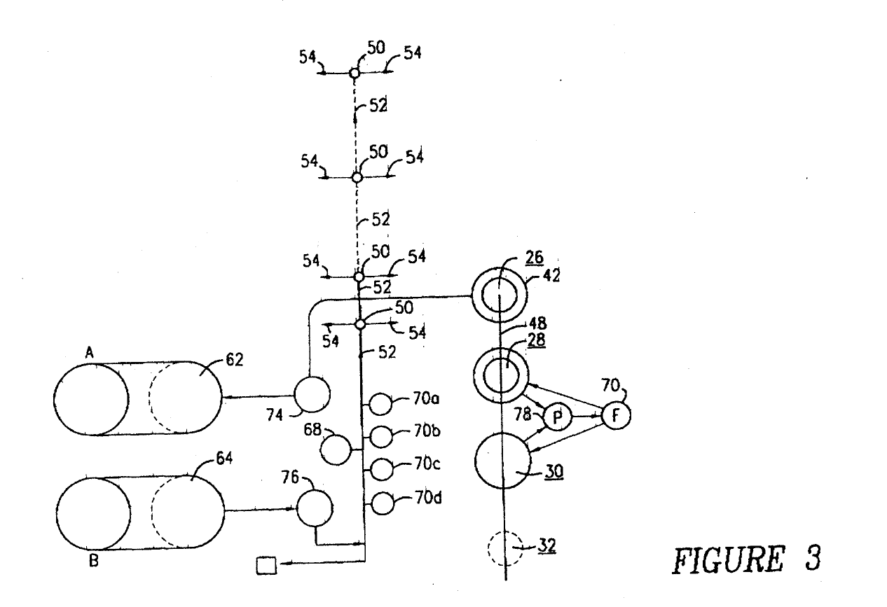

Referring to the figures and in particular to FIG. 1, there is shown a top plan view of a washing station 10 suitable for washing a plurality of landscape maintenance equipment, not shown. Provision is made to accept up to eight different pieces of equipment of different sizes for simultaneous washing. Each piece of equipment is placed in a different parking location 12a, 12b, 12c, 12d, 12e, 12f, 12g and 12h. Preferably each parking location 12a through 12h is approximately eight feet (2.4 meters) wide (14) by eleven feet (3.3 meters) long (16), spaced side by side, in two rows 18 and 20, with a walking space 22, preferably about four feet (1.2 meters) wide, provided between each station 12a thru 12h. The total area of the washing station 10 being approximately 1400 square feet (126 square meters), excluding the area 34 used for the power generator and compressor 24 and the wash drums or tanks 26, 28, 30 and debris receptacle 32 (see FIG. 3), which require an area of approximately 24 feet (7.2 meters) long and 8 feet (2.4 meters) wide or approximately 192 square feet (17.28 square meters) of reinforced concrete.

The circumference of the washing station 10 is provided with a raised portion 38 and a surface 11 sloped towards the drain or sump tank 42, disposed proximate one edge 40 thereof, to insure that the water and debris washed from the vehicles will flow towards the drain or sump tank 42. The drain or sump tank 42 is adapted to receive all of the debris and grease and oil filled dirty water from the vehicles, as well as, any natural rain water that may have fallen when no washing was being done. The sump or receiving tank 42 is covered with a heavy duty porous grate or cover 44 that has a plurality of openings therein to prevent large pieces of debris from entering the sump or drain tank 42. Drain tank 42 has disposed therein an inner removable basket 46, that can be lifted out of the tank 42 with the aid of the overhead motorized trolley, winch and pulley system 47, that is suspended from an overhead I-beam track 48. The overhead winch and pulley system 47 is also capable of tilting the basket 46 to empty the contents therein, as needed.

Each parking station 12a thru 12h is provided with underground pressurized water hose lines 52 having release nozzles 54 disposed thereon, via ten stanchions 50 placed on either side of the parking locations 12a thru 12h in the walking space 22 provided between the parking locations 12a thru 12h.

Appended to the parking station area 11 is an area 34 of reinforced concrete approximately 8 feet wide (36) by 24 feel long (37) onto which the power generator and compressor 24 is placed, as well as, the washing drums 26 and 28. Also included in the area 34, is the inlet tank 62 and the outlet tank 64. Preferably, each tank is capable of holding 1300 gallons of liquid and may reverse functions as needed. The bank of filters 68, includes filter housings and the filter bags 70a, 70b, 70c and 70d, each provided with similar input and output control valves 72, that permit water to flow into and out of the filter vessels, inlet and outlet tanks or drums 62 and 64 and open wash tanks or drums 26 and 28. Also included are pressure pumps 74, 76 and 78 and their associated control valves 72. The function of each of these components will be set forth hereinafter.

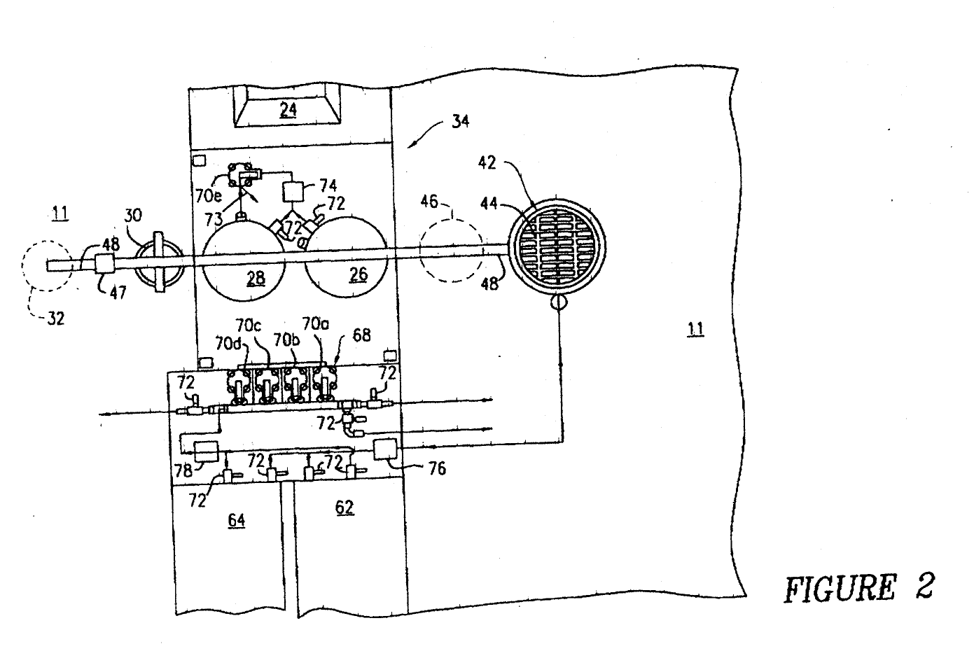

Referring now to FIG. 2, which is an enlarged and separated for clarity, plan view of the power and control area 34 of the washing station 10, that is fabricated of reinforced concrete and FIG. 3, which is a flow diagram of the washing station showing the flow, recycling of the water, the storage and the disposal of the waste materials accumulated after washing the vehicles.

In operation, the waste water and debris enters the below grade receiving sump 42, which has disposed therein a mesh receiving drum or basket 46 that may be removed from the sump 42 by the overhead trolley with motorized hoist 47 affixed on the overhead I-beam 48. The sump 42 is drained of water by suction pump 76 and discharges the water obtained into inlet tank 62. The grass debris, with oils thereon, in the basket 46 is then moved to the open wash tank 26 or 28. A valved compressed air wand, not shown, is inserted into basket 46, while it is immersed in tank 26 or 28, while the tank is filled with water and detergent. The compressed air wand is inserted into the tank and the air bubbling up from the wand washes off the oil attached to the grass. The basket 46 is raised out of the tank by the winch and pulley system 47, moved to the grass dumping station 32 where it is tilted and emptied by the winch and pulley system 47 and aided by the compressed air wand. The debris may be dumped into a container at station 32, spread on the ground, to be used as mulch, or dumped on the ground elsewhere, since it will not harm the environment.

With the aid of pump 74 and the proper positioning of valve 72, the water may be washed, filtered and pumped by pump 74 through filter 70 to the open wash tank 26 or 28, which may be repeated as needed. The filter bank 68 has three valve 72 positions and with the aid of pumps 76 and 78 and its interconnections, provides the wash water under pressure for all the wash hoses, aerates and re-filters the wash water and discharges sour or excess rain water or completely drains the tanks. Once the grease and oil are separated from the water by the filter bank 68, the filter bags, not shown, may be removed and properly disposed of The filter housings 70a thru 70h all include removable filter bags, not shown, that are readily replaceable. The liquid disposed in wash tanks 26 and 28 have their own filter housing and filter bag 70e, associated therewith and do not utilize the filter bank 68. The liquid in wash tanks 26 and 28 may be disposed of by directing a hose 73 connected to an outlet valve, not shown, towards the drain or sump 42. The valves disposed on housing 70e are normally set to discharge water into or out of wash tank 26 or 28, but may also be used to direct the water, via the hose 73, into the sump 42.

Hereinbefore has been disclosed a self-contained washing station for landscape maintenance equipment suitable for washing a plurality of vehicles that is efficient, saves time and is favorable to the environment.

Having thus set forth the nature of the invention, what is claimed is:

1. A self-contained washing station for landscape maintenance equipment, favorable to the environment, comprises in combination:
A. base means suitable for receiving a plurality of maintenance vehicles positioned thereon, said base means having;
a) a plurality of raised edges,
b) a sump storage means for retaining said water, oil and debris removed from said washed vehicles disposed below the surface of said base means positioned proximate one edge of said base means, the surface of said base means being sloped toward said sump storage means to facilitate the flow of liquid and debris disposed thereon, towards said sump storage means,
c) a removable grated cover means for retaining large pieces of debris disposed over said sump storage means, and
d) a removable porous storage container disposed within said sump storage means;
B. a movable winch and pulley system disposed above said sump storage means, extending over and beyond said one edge of said base means, suitable for lifting and tilting said grated drain cover and said removable porous storage container above the surface of said base means;
a) at least a pair of wash tanks with at least one of said wash tanks having a mesh basket disposed therein;
C. means for supplying water under pressure from underground water lines;
a) a plurality of hoses extending therefrom,
b) said hoses being connected to a plurality of washing stations disposed on said base means proximate said maintenance vehicles to be washed;
D. self-contained pumping and suction means being coupled to said water means for supplying recycled and filtered water under pressure to said plurality of washing stations; and
E. a plurality of control valve means for controlling the flow of water, air or suction in and out of the storage and filter containers and washing stations.

2. A self-contained washing station for landscape maintenance equipment, according to claim1, wherein said washing station includes pressurized water, compressed air and suction pumps powered by a portable diesel engine coupled thereto for providing all the necessary power for use by said washing station.

3. A self-contained washing station for landscape maintenance equipment, according to claim1, wherein said power area foundation is fabricated from reinforced concrete.

4. The method of simultaneously washing a plurality of landscape maintenance equipments without contaminating the environment surrounding the washing station, comprises the steps of:
A. providing base means suitable for receiving a plurality of maintenance vehicles positioned thereon;
B. providing a plurality of compressed air and suction pumps powered by a portable diesel engine coupled thereto for providing all the necessary power for use by said washing station;
C. placing a plurality of landscape maintenance equipment to be washed into different parking stations in said washing station;
D. washing said landscape maintenance vehicles with the water under pressure to be propelled towards said vehicles from each of said washing hoses under control of a valve placed in the washing hoses;
E. capturing the dirty wash water and debris washed from said vehicles:
F. washing and filtering said dirty wash water and separating the debris from the grease and oil from said dirty wash water;
G. storing said filtered grease and oil taken from said dirty wash water in a separate container for proper disposal;
H. recycling said filtered wash water for reuse by said washing station; and
J. returning the clean grass and debris to the environment.
